(19) United States
(12) Patent Application Publication
(10) Pub. No.: US 2013/0321519 A1
(43) Pub. Date: Dec. 5, 2013

(54) INKJET PEN ASSEMBLY AND METHOD FOR ADJUSTING PEN MODULE IN PRINTER

(71) Applicant: HON HAI PRECISION INDUSTRY CO., LTD., New Taipei (TW)

(72) Inventor: KUNG-HUANG TSAI, New Taipei (TW)

(73) Assignee: HON HAI PRECISION INDUSTRY CO., LTD., New Taipei (TW)

(21) Appl. No.: 13/837,196

(22) Filed: Mar. 15, 2013

(30) Foreign Application Priority Data
May 30, 2012 (TW) 101119357

(51) Int. Cl. B41J 2/135

(52) U.S. Cl. CPC B41J 2/135
USPC 347/20

(57) ABSTRACT

An inkjet pen assembly includes a mounting bracket, a pen module, a magnet, a wheel, and a driving member. The mounting bracket includes a supporting board and a driving board. The pen module is rotatably mounted to the supporting board. The magnet is located on the pen module. The wheel and the driving member are rotatably mounted to the pen module. A plurality of individually-activated electromagnets is located on an outer edge of the wheel. At least one of the plurality of electromagnets is activated to drive the driving member to rotate by attracting or repelling the magnet. When the driving member is rotated, the driving member pushes the driving board to adjust a distance or an angle of the pen module, relative to the supporting board.

### BACKGROUND

The disclosure generally relates to an inkjet pen assembly and a method for adjusting a pen module in printer.

### DESCRIPTION OF RELATED ART

Inkjet printing creates an image by propelling droplets of ink onto paper. The inkjet printer usually includes a movable pen for jetting ink onto paper. A Pen to Platen Space (PPS) is defined between the pen and a platen which is used for supporting papers. The PPS determines a printing quality of the paper. A traditionally pen in the printer is driven by a motor through gears to adjust the PPS. However, there is a lot of complexity and moving parts involved in adjusting the pen. There is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an inkjet pen assembly in one embodiment.

FIG. 2 is an assembled view of the inkjet pen assembly.

FIG. 3 is a lateral view of the inkjet pen assembly of FIG. 2.

FIG. 4 is similar to FIG. 3, but a pen platen being biased.

FIG. 5 is similar to FIG. 4, but the pen platen being biased to another aspect.

FIG. 6 is an assembled view of an inkjet pen assembly in another embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

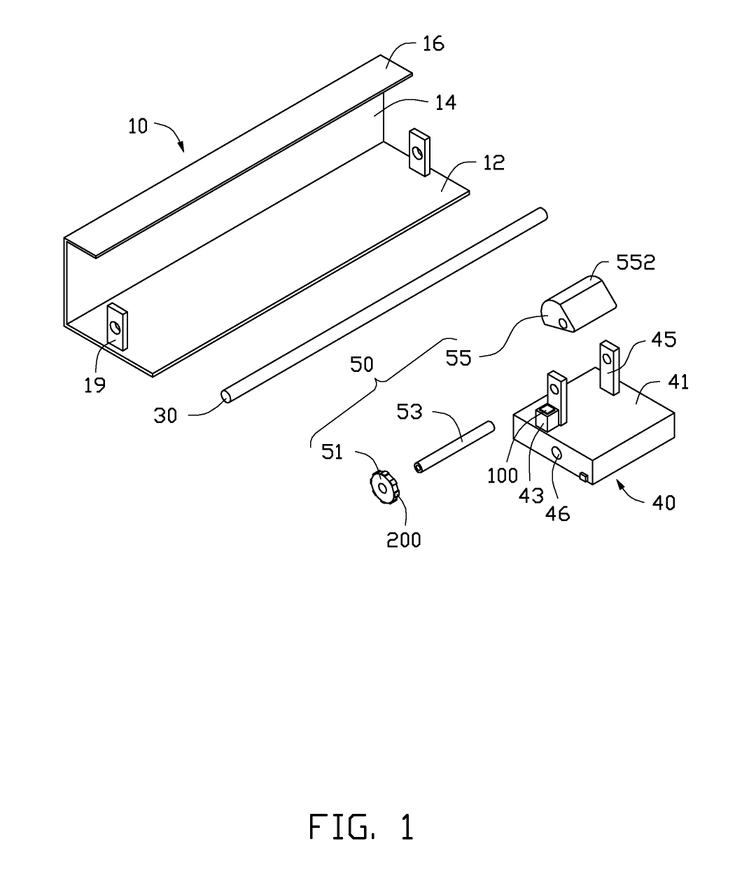

FIG. 1 is one embodiment of an inkjet pen assembly which can be used in an inkjet printer. The inkjet pen assembly includes a mounting bracket 10, a shaft 30, a pen platen 40 and a driving device 50 mounted on the pen platen 40.

The mounting bracket 10 includes a supporting board 12, a driving board 16, and a connecting board 14 connecting the supporting board 12 to the driving board 16. The supporting board 12 and the driving board 16 are substantially parallel to each other. A pair of first stands 19 is located on the supporting board 12. In one embodiment, the shaft 30 is pivotable on the pair of first stands 19.

The pen platen 40 includes a pen module 41, a tab 43 located on the pen module 41, a pair of second stands 45 located on the pen module 41 for supporting the driving device 50. A through hole 46 is defined in the pen module 41 for receiving the shaft 30. A magnet 100 is located on the tab 43. The magnet 100 may attract or repel other magnets or electromagnets.

The driving device 50 includes a roller 53, a wheel 51 and a driving member 55. The roller 53 is pivotably mounted to the pair of second stands 45. The wheel 51 and the driving member 55 are attached to the roller 53. The wheel 51 may be circular, ellipsoid, or a polygon. A plurality of electromagnets 200 is located on the outer edge of the wheel 51. The number of the electromagnets 200 is predetermined depending on the desired adjusting accuracy. Each of the plurality of electromagnets 200 can be individually activated. In one embodiment, the plurality of electromagnets 200 includes eight electromagnets. The positive or negative polarity of each electromagnet 200 can be changed by reversing an input current. The driving member 55 includes a cam. The driving member 55 includes an arcuate contact surface 552.

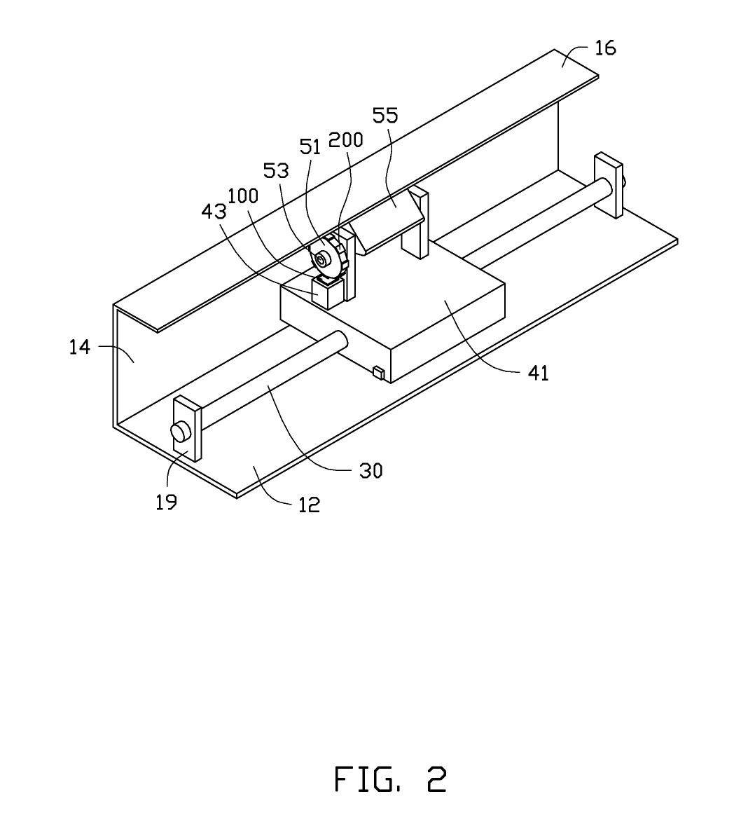

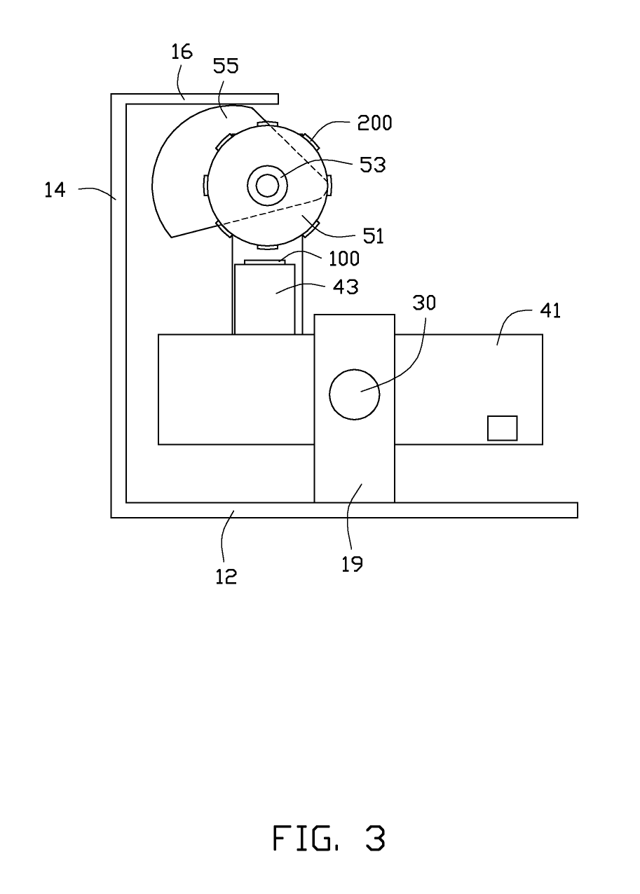

Referring to FIG. 2 and FIG. 3, in assembly, the pen platen 40 is attached to the shaft 30. The shaft 30 is rotatably mounted to the first stands 19. The magnet 100 is located on the tab 43. The driving member 55 is mounted to the roller 53. The roller 53 extends through the pair of second stands 45. The wheel 51 with the plurality of electromagnets 200 is mounted to one side of the roller 53. The wheel 51 is located on top of the magnet 100. A space is left between the magnet 100 and the wheel 51. The driving member 55 is located under the driving board 16. The wheel 51 and the driving member 55 are located on a first side of the pen module 41.

To balance the pen module 41, the center of gravity of the pen module 41 is biased to a second side of the pen module 41, opposite to the first side. The pen module 41 can lift up the driving member 55 on the first side of the pen module 41 so that the driving member 55 can abut the driving board 16. In other embodiments, the pen platen 40 can be balanced by means of a coil spring sleeved on the shaft 30.

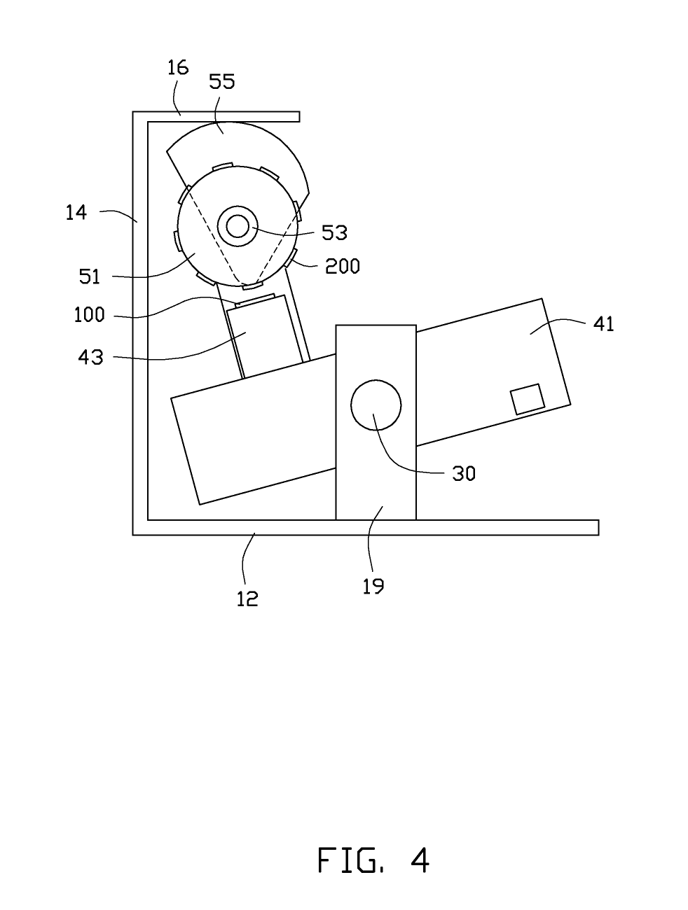

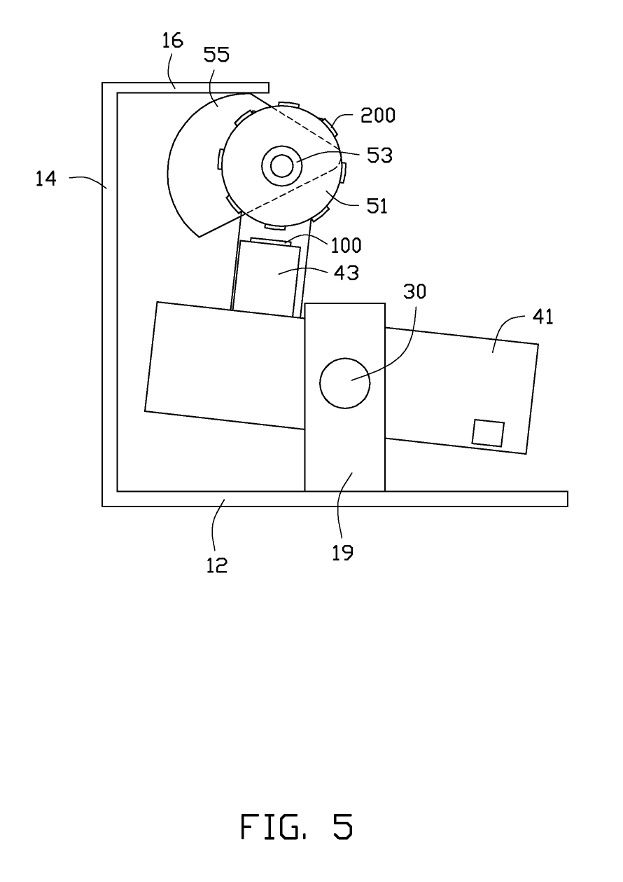

Referring to FIG. 4 and FIG. 5, when adjusting the pen module 41, one or more of the plurality of electromagnets 200 is powered. The one or more of the plurality of electromagnet 200 thus attracts or repels the magnet 100. The driving member 55 with the wheel 51 is thus driven to rotate. The outer surface of the driving member 55 pushes the driving board 16 down against the pen module 41 on the first side. The angle of the pen module 41 relative to the supporting board 12 is therefore adjusted. Electrical power to the plurality of electromagnets 200 can be switched as desired to rotate the wheel 51 and further adjust the angle of the pen module 41.

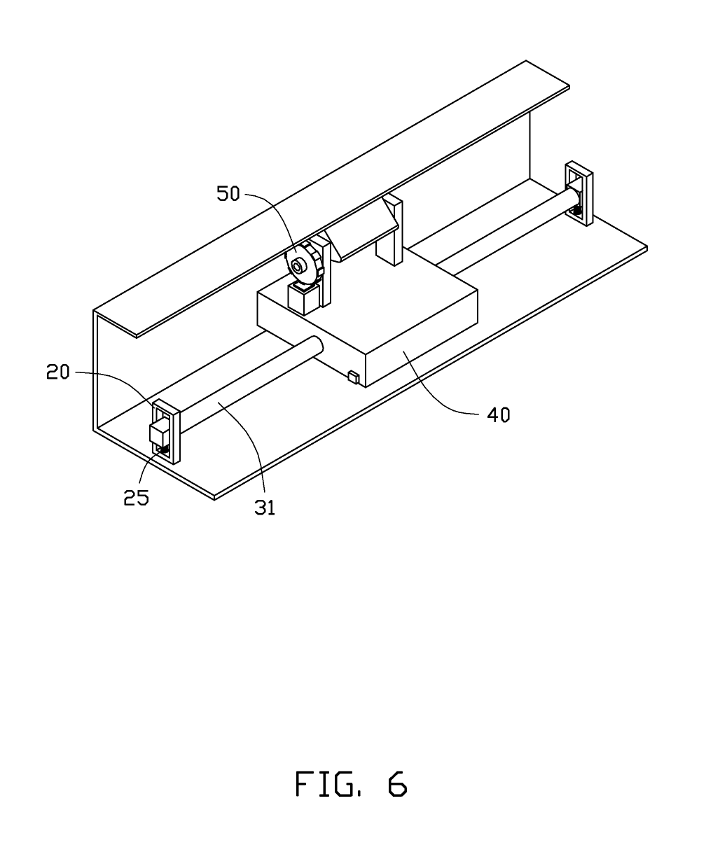

Referring to FIG. 6, in another embodiment, a spring device 25 is located under the shaft 30. The pen platen 40 can be moved vertically relative to the supporting board 12, to adjust a distance between the pen module 41 and the supporting board 12.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An inkjet pen assembly, comprising:
a mounting bracket comprising a supporting board and a driving board;
a pen module rotatably mounted to the supporting board;
a magnet located on the pen module; and
a wheel and a driving member rotatably mounted to the pen module, a plurality of electromagnets located on an outer edge of the wheel;
wherein at least one of the plurality of electromagnets is configured to be powered to drive the driving member to rotate according to attracting or repelling the magnet, and when the driving member is rotated, the driving member pushes the driving board to adjust a distance or an angle of the pen module relative to the supporting board.

2. The inkjet pen assembly of claim 1, wherein the driving member comprises a cam, and the driving member includes an arcuate surface.

3. The inkjet pen assembly of claim 1, wherein the pen module is rotated about a shaft, the magnet, the wheel and the driving member are located on a side of the shaft; and the driving member is configured to push down the pen module on the side of the driving member to adjust the angle, when the driving member rotates and pushes the driving board.

4. The inkjet pen assembly of claim 3, wherein the pen module is configured to lift up the driving member on the side of the pen module, when the driving member is released from the driving board.

5. The inkjet pen assembly of claim 3, wherein the wheel and the driving member rotate about a roller, and the roller is substantially parallel to the shaft.

6. The inkjet pen assembly of claim 1, wherein when the magnet attracts or repels one of the plurality of electromagnets, a space is defined between the magnet and the one of the plurality of electromagnets.

7. The inkjet pen assembly of claim 1, wherein the plurality of electromagnets is substantially equally spaced to each other.

8. The inkjet pen assembly of claim 1, wherein the pen module is movably mounted to the supporting board, and the driving member is configured to push the driving board to adjust the distance of the pen module relative to the supporting board.

9. The inkjet pen assembly of claim 1, wherein the supporting board is substantially parallel to the driving board.

10. A method for adjusting a pen module in an inkjet pen assembly, the pen module is located on a mounting bracket, the bracket comprising a supporting board and a driving board, the method comprising:
positioning a magnet, a wheel and a driving member on the pen module; wherein the wheel and the driving member are rotatably mounted to the pen module, and a plurality of electromagnets located on an outer edge of the wheel;
powering at least one of the plurality of electromagnets, the magnet attracting or repelling the at least one of the plurality of electromagnets, the driving member rotating with the wheel, and a distance or an angle between the pen module and the supporting board being adjusted through pushing the driving board by the driving member.

11. The method of claim 10, wherein the driving member comprises a cam, and the driving member includes an arcuate surface.

12. The method of claim 10, wherein the pen module is rotated about a shaft, the magnet, the wheel and the driving member are located on a side of the shaft; and the driving member is configured to push down the pen module on the side of the shaft to adjust the angle, when the driving member rotates and pushes the driving board.

13. The method of claim 12, wherein the pen module is configured to lift up the driving member on the side of the pen module, when the driving member is released from the driving board.

14. The method of claim 12, wherein the wheel and the driving member rotate about a roller, and the roller is substantially parallel to the shaft.

15. The method of claim 10, wherein when the magnet attracts or repels one of the plurality of electromagnets, a space is defined between the magnet and the one of the plurality of electromagnets.

16. The method of claim 10, wherein the plurality of electromagnets is substantially equally spaced to each other.

17. The method of claim 10, wherein the pen module is movably mounted to the supporting board, and the driving member is configured to push the driving board to adjust the distance of the pen module relative to the supporting board.

18. The method of claim 10, wherein the supporting board is substantially parallel to the driving board.
